(19) United States
(12) Patent Application Publication
(10) Pub. No.: US 2011/0188038 A1
(43) Pub. Date: Aug. 4, 2011

(54) Label-Independent Optical Reader System And Methods With Optical Scanning

(76) Inventors: Jacques Gollier, Painted Post, NY (US); Garrett Andrew Piech, Horseheads, NY (US); Michael Brian Webb, Lindley, NY (US)

(21) Appl. No.: 12/850,075

(22) Filed: Aug. 4, 2010

Related U.S. Application Data
(60) Provisional application No. 61/231,446, filed on Aug. 5, 2009.

(51) Int. Cl. G01J 3/28

(52) U.S. Cl. 356/328

(57) ABSTRACT

Optical reader systems and methods for label-independent reading of resonant waveguide (RWG) biosensors operably supported by a microplate as defined herein. The system includes a light source, a spectrometer unit, a beam-forming optical system and a scanning optical system that includes a scanning mirror device, a mirror device driver operably coupled to the scanning mirror device, and an F-theta lens arranged between the microplate and the beam-forming optical system. Some systems use multiple optical beams to scan multiple biosensors at once without having to move the microplate. Asynchronous scanning of multiple beams allows for reducing the number of spectrometer units needed.

### CLAIMING BENEFIT OF PRIOR FILED U.S. APPLICATION

This application claims the benefit of U.S. Provisional Ser. No. 61/231,446, filed on Aug. 5, 2009. The content of this document and the entire disclosure of any publication, patent, or patent documents mention herein are incorporated by reference.

### FIELD

The present disclosure relates to label-independent optical reader systems and methods that use one or more scanned optical beams to interrogate one or more biosensors.

### BACKGROUND

Manufacturers of optical reader systems seek to design a new and improved optical reader systems that can be used to interrogate a resonant waveguide grating biosensor to determine if a biomolecular binding event (e.g., binding of a drug to a protein) occurred on a surface of the biosensor. Of present interest is reducing the cost and size of such optical reader systems. Such new and improved optical reader systems and methods are the subject of the present disclosure.

### SUMMARY

An aspect of the disclosure is an optical reader system for label-independent reading of resonant-waveguide (RWG) biosensors operably supported by a microplate. The system includes a holder configured to operably hold the microplate, a light source that generates light, and a spectrometer unit. The system also includes a beam-forming optical system having input and output ends. The beam-forming optical system is optically coupled to the light source at the input end and forms least one optical beam at the output end. The beam-forming optical system is also optically coupled to the spectrometer unit at the input end to direct light received at the output end to the spectrometer unit. The system further includes a scanning optical system arranged between the microplate and the beam-forming optical system and having a scanning mirror device, a mirror device driver operably coupled to the scanning mirror device, and an F-theta lens. The scanning optical system is configured to receive and scan the at least one optical beam over one or more of the RWG biosensors and to direct light reflected by the one or more scanned RWG biosensors back to the output end of the beam-forming optical system.

Another aspect of the disclosure is an optical reader system for label-independent reading of RWG biosensors operably supported by a microplate. The system includes at least one light source that generates light, at least one spectrometer unit, and first and second beam-forming optical systems. The first and second beam-forming optical systems each have input and output ends and are optically coupled to either different light sources or to the at least one light source at their respective input ends to form at least one first optical beam and at least one second optical beam at their respective output ends. Each of the first and second beam-forming optical systems are optically coupled to either different spectrometer units or to the at least one spectrometer unit at their respective input ends to direct thereto light received at their respective output ends. The system also includes first and second scanning optical systems, respectively, arranged between the microplate and the first and second beam-forming optical systems. The first and second scanning optical systems, respectively, include first and second scanning mirror devices, first and second mirror device drivers respectively operably connected to the first and second scanning mirror devices, and first and second F-theta lenses, respectively, operably arranged relative to the first and second scanning mirror devices. The first and second scanning optical systems are respectively configured to scan the at least one first optical beam and the at least one second optical beam over respective RWG biosensors, and to direct light reflected by the scanned biosensors back to the corresponding output ends of the first and second beam-forming optical systems.

Another aspect of the disclosure is a method of reading an array of RWG biosensors operably supported by a microplate. The method includes generating at least one optical beam using at least one beam-forming optical system that is optically connected to a light source and to a spectrometer unit. The method also includes providing at least one scanning optical system having a scanning mirror device, a mirror driver operably coupled to the scanning mirror device, and an F-theta lens operatively arranged relative to the adjustable mirror. The method can additionally include operating the at least one scanning optical system to effectuate scanning of the at least one optical beam over at least one RWG biosensor without moving the microplate to generate a reflected optical beam therefrom. The method can also include directing light from the reflected optical beam to the spectrometer through the at least one scanning optical system and the at least one beam-forming optical system to form at least one measurement spectrum. The method further includes processing the at least one measurement spectrum to establish at least one resonant wavelength associated with the at least one scanned RWG biosensor.

Another aspect of the invention is a method of reading a resonant waveguide (RWG) biosensor having a resonant wavelength. The method includes forming a scanned optical beam having a light spot smaller than the RWG biosensor. The method also includes scanning the light spot in a two-dimensional scan path over at least a portion of the RWG biosensor thereby forming reflected light containing resonant wavelength information. The method further includes collecting the reflected light over the scan path. The method further includes determining from the reflected light an integrated measurement of the resonant wavelength.

These and other advantages of the disclosure will be further understood and appreciated by those skilled in the art by reference to the following written specification, claims and appended drawings.

### BRIEF DESCRIPTION OF THE DRAWINGS

A more complete understanding of the present disclosure may be had by reference to the following detailed description when taken in conjunction with the accompanying drawings wherein:

FIG. 1 is a generalized schematic diagram of an optical reader system of the disclosure;

FIG. 2 shows an exemplary biosensor array operably supported in regions or “wells” of a microplate, which in turn is held by a microplate holder;

FIG. 3 is a plot of resonant wavelength λ_{R} (nm) vs. position (mm) across the biosensor;

FIG. 4 is a plot of the peak amplitude (photon counts) versus spectrometer pixel location, which corresponds to wavelength;

FIG. 5 is a detailed schematic diagram of a single-channel embodiment of a scanning optical reader system of the disclosure;

FIG. 6 is a close-up schematic diagram of an exemplary scanning optical system that includes a scanning mirror device, a fold mirror, and an F-theta focusing lens;

FIG. 7 is a plot of the measured resonant wavelength λ_{R} (pm) versus X and Y position (mm) (solid and dashed lines, respectively) of the incident optical beam light spot as measured on several biosensors;

FIG. 8 is a close-up view of an example biosensor showing an exemplary scan path of the incident optical beam light spot over the biosensor;

FIG. 9 is a plot similar to FIG. 7 and shows experimental measurements of the positioning sensitivity as the same biosensors are scanned in two dimensions rather than one dimension;

FIG. 10 is a plot similar to FIG. 9 and shows the resonant wavelength variation as a function of the tip and tilt of the microplate for several biosensor measurements;

FIG. 11 is a schematic close-up view of a portion of the scanning optical system for a single-channel optical reader system and illustrates another exemplary system alignment method that employs a beam splitter and a detector;

FIG. 12 illustrates an exemplary embodiment of a method of establishing the position of the microplate or biosensor by dithering the light spot about a biosensor edge;

FIG. 13 is a schematic close-up view of a portion of the scanning optical system similar to FIG. 11 and illustrating an exemplary fiber array used to provide the optical reader system with multiple channels;

FIG. 14 is a schematic close-up view of a portion of the optical reader system associated with an n-channel embodiment, showing n fibers leading to n spectrometers;

FIG. 15 is a schematic diagram of a dual-head optical reader system;

FIG. 16 is a schematic diagram of an exemplary configuration of the two scanning optical systems (right and left) suitable for use in the dual scanning optical reader system of FIG. 15;

FIG. 17 is schematic diagram similar to FIG. 15 that illustrates an exemplary embodiment of dual scanning optical reader system that uses only one set of one or more spectrometer units; and

FIG. 18 is similar to FIG. 17 and illustrates a simplified example embodiment wherein the dual scanning optical reader system includes a single coupling device, a single light source and a single spectrometer unit.

### DETAILED DESCRIPTION

Reference is now made to embodiments of the disclosure, exemplary embodiments of which are illustrated in the accompanying drawings.

In the discussion below, angle θ is a “deflection angle” and refers to the angle of incident optical beams 134I relative to optical axis A1 as these optical beams leave scanning mirror device 260. The angle φ refers to an “incidence angle” that the incident optical beams 134I make relative to the surface normal N of microplate 170. Microplate 170 is assumed to lie in an X-Y plane thereby defining deflection angles θ_{X} and θ_{Y} and incident angles φ_{X} and φ_{Y} associated with incident optical beam(s) 134I.

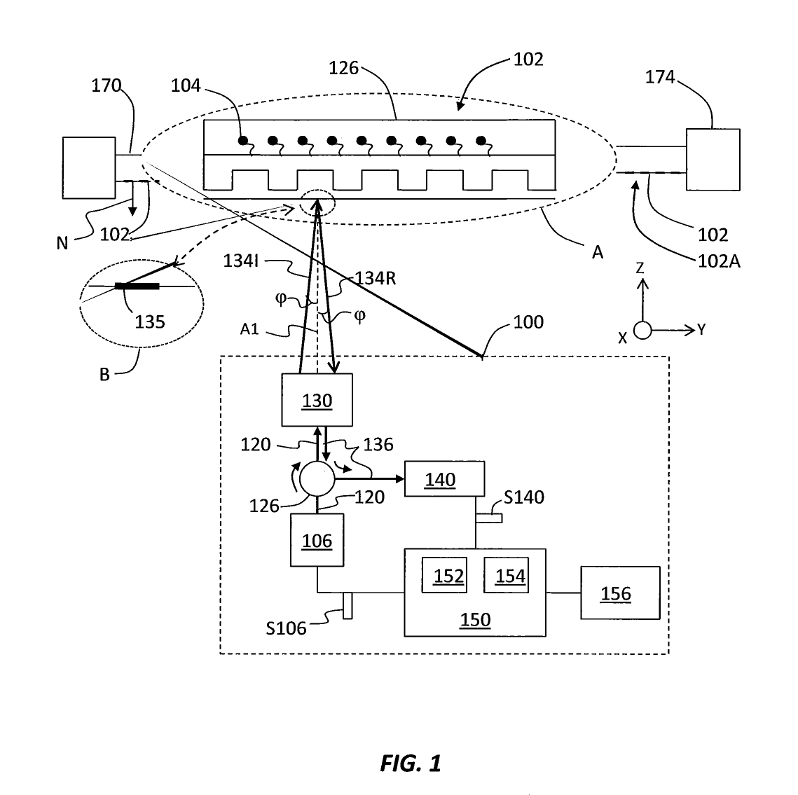

FIG. 1 is a generalized schematic diagram of an optical reader system (“system”) 100 of the present disclosure and used to interrogate one or more biosensors 102 each having a surface 103 to determine if a biological substance 104 is present on the biosensor. Inset A shows a close-up of an exemplary biosensor 102. Biosensor 102 may be, for exemplary, a resonant waveguide grating (RWG) biosensor, a surface plasmon resonance (SPR) biosensor, or like biosensor.

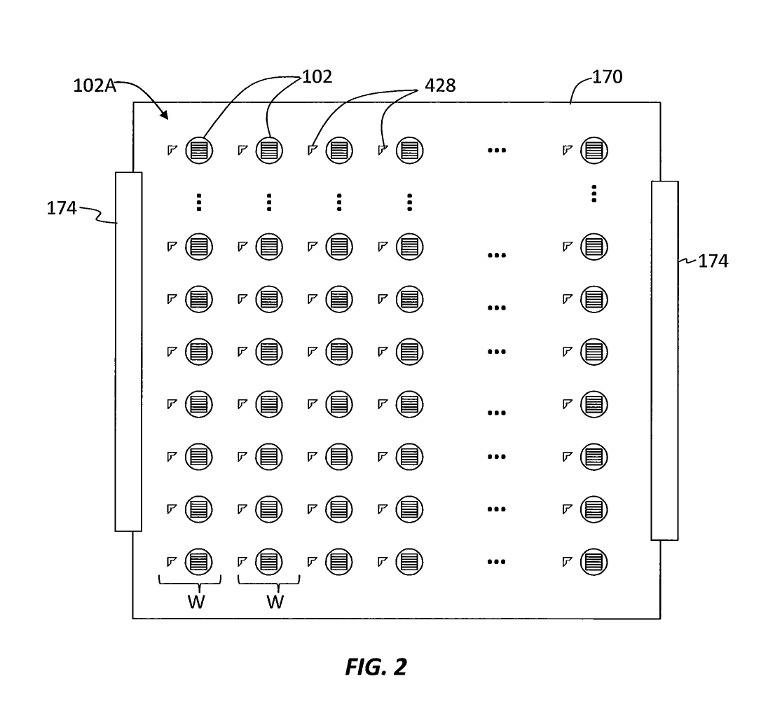

FIG. 2 shows an exemplary configuration where biosensors 102 are arranged in an array 102A and operably supported in regions or “wells” W of a microplate 170. An exemplary biosensor array 102A has a 4.5 mm pitch for biosensors 102 that are 2 mm square, and includes 16 biosensors per column and 24 biosensors in each row. Fiducials 428 that can be used to position, align, or both, the microplate 170 in system 100. A microplate holder 174 is also shown holding microplate 170. Many different types of plate holders can be used as microplate holder 174.

With reference again to FIG. 1, optical reader system 100 includes a light source assembly 106 (e.g., lamp, laser, diode, filters, attenuators, etc.) that generates light 120. Light 120 is directed by a coupling device 126 (e.g., a circulator, optical switch, fiber splitter or the like) to a scanning optical system 130 that has an associated optical axis A1 and that transforms light 120 into an incident optical beam 134I, which forms a light spot 135 at biosensor 102 (see inset B). Incident optical beam 134I (and thus light spot 135) is scanned over the biosensor 102 by the operation of scanning optical system 130. In prior art systems, the biosensor 102 is moved so the incident optical beam can be scanned across the biosensor 102. However, in the present disclosure, the incident optical beam 134I is scanned across a stationary biosensor 102 using scanning optical system 130, as described further below.

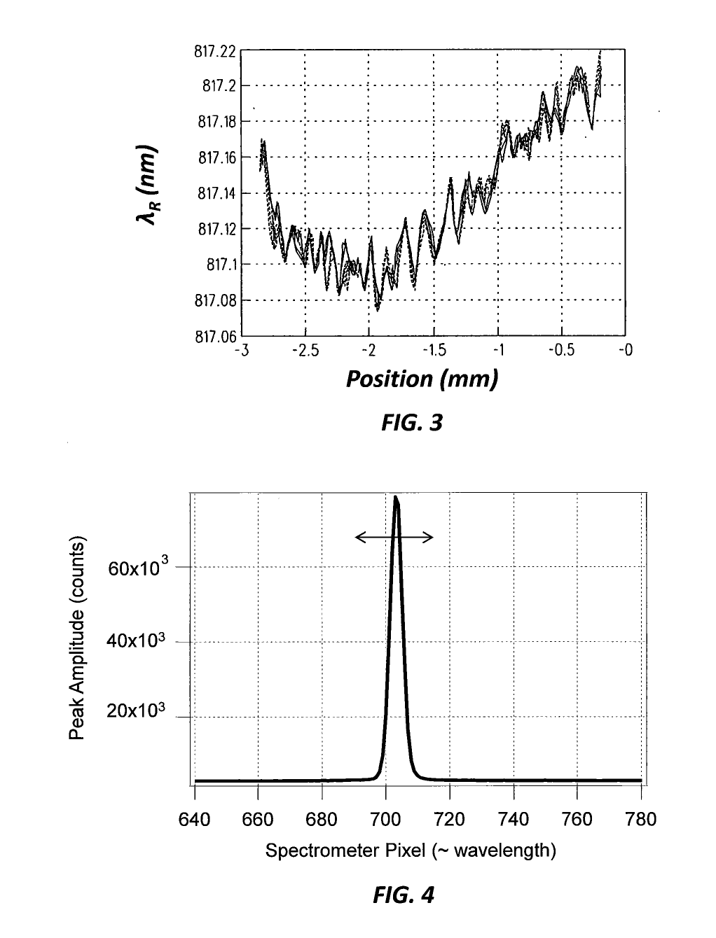

Incident optical beam 134I reflects from biosensor 102, thereby forming a reflected optical beam 134R. Reflected optical beam 134R is received by scanning optical system 130 and light 136 therefrom (hereinafter, “guided light signal”) is directed by coupling device 126 to a spectrometer unit 140, which generates an electrical signal S140 representative of the spectra of the reflected optical beam. In embodiments, a controller 150 having a processor unit (“processor”) 152 and a memory unit (“memory”) 154 then receives electrical signal S140 and stores in the memory the raw spectral data, which is a function of a position (and possibly time) on biosensor 102. Thereafter, processor 152 analyzes the raw spectral data based on instructions stored therein or in memory 152. The result is a spatial map of resonant wavelength (X_{R}) data such as shown in FIG. 3, which shows the calculated resonance centroid as a function of the position of the scanning spot across the sensor for a number of different scans. The variation of the resonance wavelength indicates if a chemical or biological reaction happened for a specific sensor. In embodiments, controller 150 includes or is operably connected to a display unit 156 that displays measurement information such as spectra plots, resonant wavelength plots, and other measurement results, as well as system status and performance parameters. In another embodiments, spectra can be processed immediately so that only the wavelength centroid is stored in memory 154.

Example biosensors 102 make use of changes in the refractive index at sensor surface 103 that affect the waveguide coupling properties of incident optical beam 134I and reflected optical beam 134R to enable label-free detection of biological substance 104 (e.g., cell, molecule, protein, drug, chemical compound, nucleic acid, peptide, carbohydrate) on the biosensor. Biological substance 104 may be located within a bulk fluid deposited on biosensor surface 103, and the presence of this biological substance alters the index of refraction at the biosensor surface.

To detect biological substance 104, biosensor 102 can be probed with incident optical beam 134I, and reflected optical beam 134R is received at spectrometer unit 140. Controller 150 can be configured (e.g., processor 152 is programmed) to determine if there are any changes (e.g., 1 part per million) in the biosensor refractive index caused by the presence of biological substance 104. In embodiments, biosensor surface 103 can be coated with, for example, biochemical compounds (not shown) that only allow surface attachment of specific complementary biological substances 104, thereby enabling biosensor 102 to be both highly sensitive and highly specific. In this way, system 100 and biosensor 102 can be used to detect a wide variety of biological substances 104. Likewise, biosensor 102 can be used to detect the movements or changes in cells immobilized to biosensor surface 103, for example, when the cells move relative to the biosensor or when they incorporate or eject material a refractive index change occurs.

If multiple biosensors 102 are operably supported as an array 102A in wells W of microplate 170, which in turn is supported by microplate holder 174, then they can be used to enable high-throughput drug or chemical screening studies. For a more detailed discussion about the detection of a biological substance 104 (or a biomolecular binding event) using scanning optical reader systems, reference is made to U.S. patent application Ser. No. 11/027,547, which is incorporated by reference herein. Other optical reader systems are described in U.S. Pat. No. 7,424,187 and U.S. Patent Application Publications No. 2006/0205058 and 2007/0202543, which patent and patent application publications are incorporated by reference herein.

The most commonly used technique for measuring biochemical or cell assay events occurring on RWG-based biosensors 102 is spectral interrogation. Spectral intenogation entails illuminating biosensor 102 with a multi-wavelength or broadband beam of light (incident optical beam 134I), collecting the reflected light (reflected optical beam 134R), and analyzing the reflected spectrum with spectrometer unit 140. An exemplary reflection spectrum from an example spectrometer unit 140 is shown in FIG. 4, where the “peak amplitude” is the number of photon counts as determined by an analog-to-digital (A/D) converter in the spectrometer. When chemical binding occurs at biosensor surface 103, the resonance shifts slightly in wavelength as indicated by the double arrow, and such shift can be detected by spectrometer unit 140.

While the general concept of spectral interrogation of biosensor 102 is straightforward, the implementation details of how light can be delivered to and collected from the biosensor can have a major impact on the quality of the data and practical utility of system 100. For example, due to inevitable non-homogeneity of the resonant wavelength λ_{R} across biosensors 102, the measured resonant wavelength λ_{R} is extremely sensitive to the position of incident optical beam 134I over the biosensor.

### Single-Channel Scanning Optical Reader System

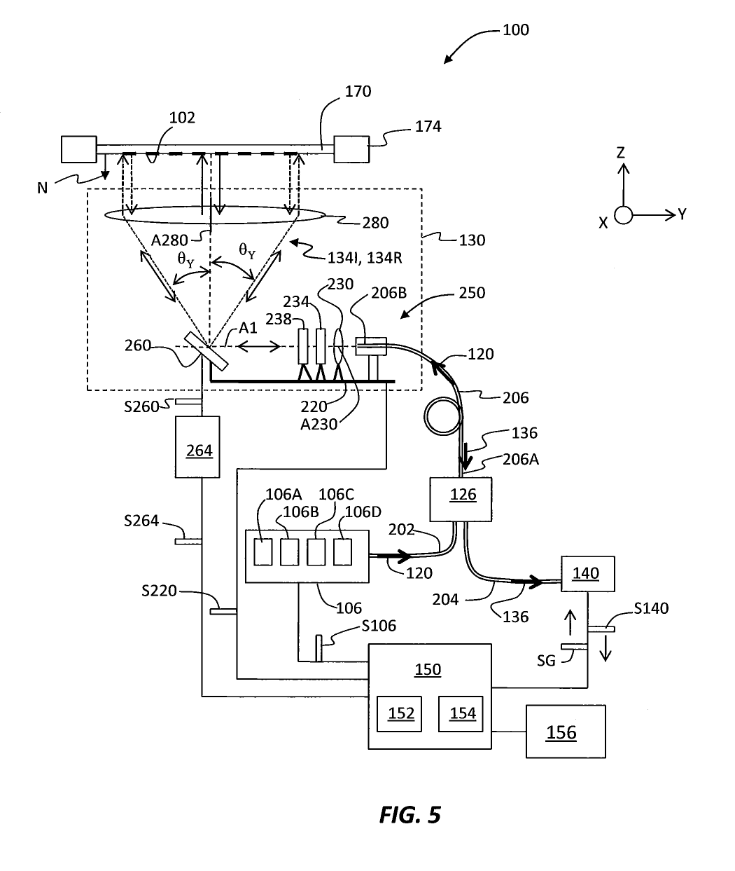

FIG. 5 is a detailed schematic diagram of a single-channel embodiment of system 100 of the present disclosure. Cartesian X-Y-Z coordinates are shown for reference. An exemplary light source assembly 106 comprises a light source 106A, a variable optical attenuator 106B, a polarization scrambler 106C and an optical isolator 106D. Polarization scrambler 106C serves to randomize the polarization of light 120, and optical isolator 106D serves to prevent scattered or reflected light from returning to light source 106A.

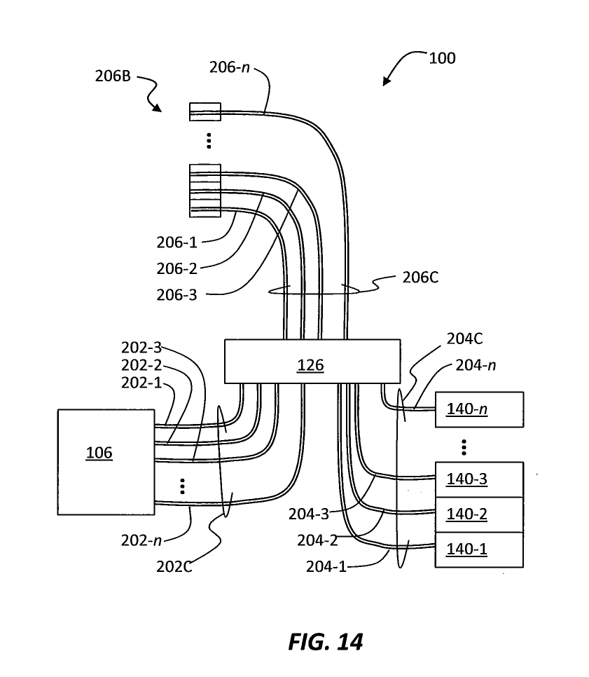

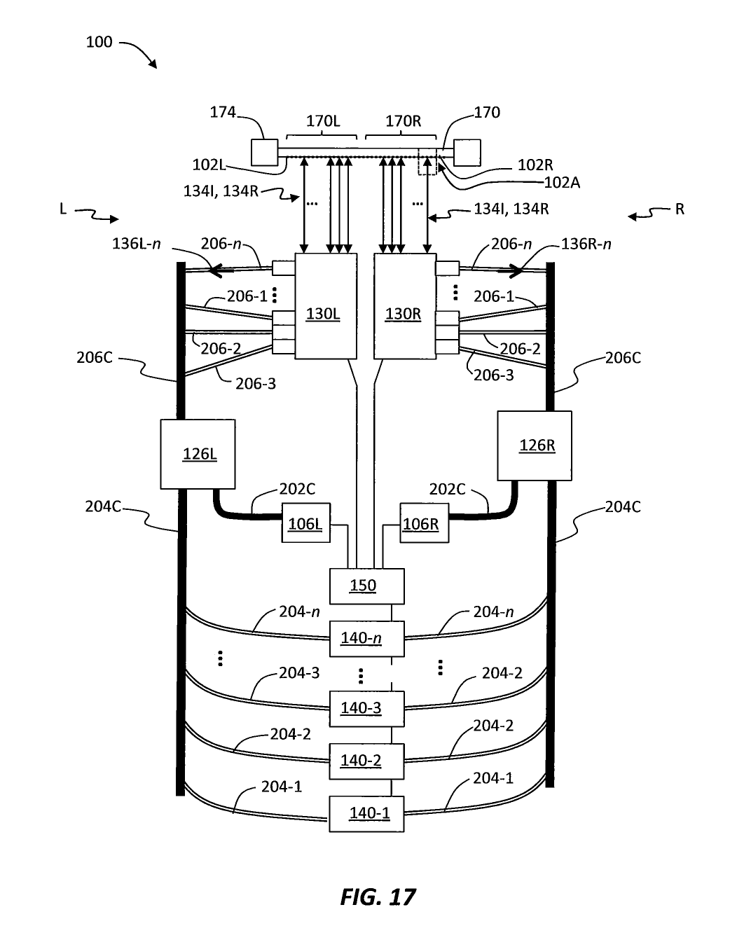

An exemplary light source 106A includes a wide spectrum source such as a superluminous diode (SLD). Light source assembly 106 is optically connected by a first optical fiber section 202 to coupling device 126, which in the present embodiment is a 1×2 fiber splitter. Spectrometer unit 140 comprises a spectrometer, such as an HR-2000 spectrometer, available from Ocean Optics, Dunedin, Fla. Spectrometer unit 140 can be connected by a second optical fiber section 204 to coupling device 126. A third optical fiber section 206 can be connected at one end 206A to coupling device 126, while the other end portion 206B can be mounted on a X-Y-Z translation stage 220. Also mounted on translation stage 220 can be a focusing lens 230 having a focal length f2, a linear polarizer 234 and a quarter-wave plate 238. Note that focusing lens 230 may comprise one or more optical elements. Fiber section end 206A, focusing lens 230, linear polarizer 234 and quarter-wave plate 238 constitute an adjustable beam-forming optical system 250 that shares the aforementioned optical axis A1. In embodiments, translation can be manually adjustable, while in other embodiments stage 220 can be adjustable under the control of controller 150 via a control signal S220. In an exemplary embodiment, the first, second, and third fiber sections 202, 204 and 206 can be single-mode (SM) fiber sections. In exemplary embodiments discussed below, fiber sections 202, 204, and 206 can be carried by respective optical fiber cables 202C, 204C and 208C (see FIG. 14 and FIG. 17) that carry one or more of the respective fiber sections.

System 100 can also include a scanning mirror device 260 arranged along optical axis A1 adjacent beam-forming optical system 250. Scanning mirror device 260 can be, for example, a micro-electro-mechanical system—(MEMS)-based mirror, such as is available from Mirrorcle Technologies, Inc., Albany, Calif., or from Texas Instruments, Dallas, Tex., as model TALP 1011, for example. Other exemplary embodiments of scanning mirror device 260 can include a scanning galvanometer, a flexure-based scanning mirror, an oscillating plane mirror, a rotating multifaceted mirror, and a piezo-electric-driven mirror. Scanning mirror device 260 can be adapted to scan in at least one dimension (1D) and preferably two-dimensions (2D) (i.e., along axes X and Y, thereby defining associated scanning angles θ_{X} and θ_{Y}). Scanning mirror device 260 can be operably connected to a mirror device driver 264, which may be based on voltage or current depending on the nature of scanning mirror device 260. In embodiments, scanning mirror device 260 can be mounted on translation stage 220.

A field lens 280 can be arranged along optical axis A1 adjacent scanning mirror device 260 and opposite beam-forming optical system 250. In embodiments, field lens 280 has an F-theta configuration wherein light from any angle θ is directed substantially parallel to optical axis A1 (i.e., φ˜0°). Suitable F-theta field lenses 280 are commercially available from optics suppliers, such as Edmund Optics, Barrington, N.J. Field lens 280 has a focal length f1 and comprises at least one optical element. In embodiments, field lens 280 comprises multiple optical elements, including at least one mirror, or at least one lens, or a combination of at least one mirror and at least one lens. In an exemplary embodiment, field lens 280 includes one or more aspherical surfaces.

System 100 also includes the aforementioned microplate holder 174 configured to operably support microplate 170, which in turn is configured to operably support an array of biosensors 102. In an exemplary embodiment, the position of microplate holder 174 is adjustable so that the position of microplate 170 can be adjusted relative to optical axis A1. Scanning mirror device 260 is located at the focus of field lens 280, i.e., at a distance f1 from the field lens.

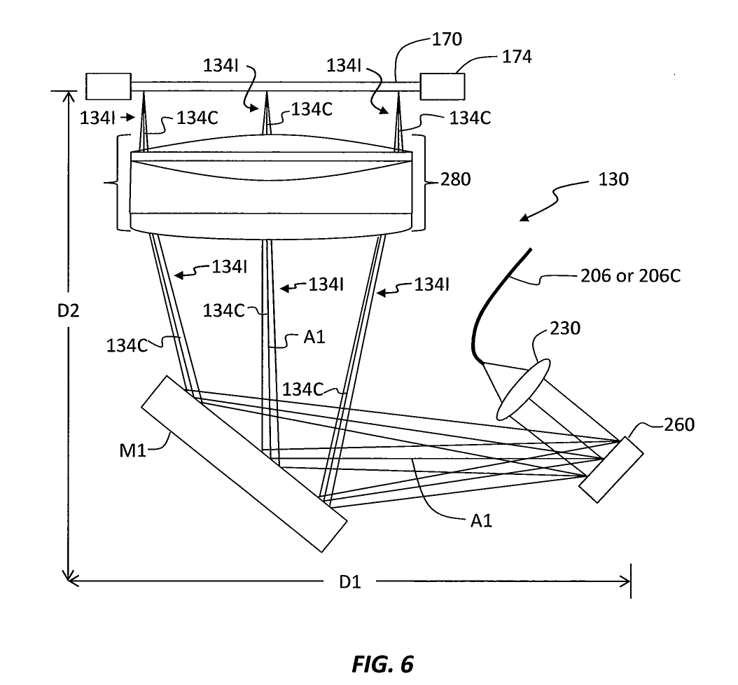

FIG. 6 is a close-up schematic diagram of an exemplary scanning optical system 130 shown optically coupled to beam-forming optical system 250 and that includes scanning mirror device 260, a fold mirror M1, and F-theta field lens 280. Also shown is microplate holder 174 with microplate 170 supported thereby. Fold mirror M1 can be used to fold optical axis A1 and thus fold the optical path to make scanning optical system 130 more compact. In embodiments, focusing lens 230 has a focal length f2=10 mm and field lens 280 has a focal length f1=200 mm with an aperture of 72 mm. This particular configuration for scanning optical system 130 fits within dimensions L1×2=140 mm×140 mm and thus has a relatively compact form factor. In embodiments, beam-forming optical system 250 can be included in scanning optical system 130.

The size of the microplate 170 that can be scanned by scanning mirror device 260 is given by the tangent of the mirror deflection multiplied by the focal length of the field lens 280. So, with +/−10 degrees of optical deflection and a 200 mm focal length field lens 280, a 72 mm area can be scanned in both the X- and Y-directions.

The exemplary scanning optical system 130 of FIG. 6 is capable of interrogating a single microplate column of biosensors 102 when configured in a standard microplate format of sixteen wells per column on a 4.5 mm pitch, or about a 72 mm total distance. An exemplary nominal size of light spot 135 formed by incident optical beam 134I at microplate 170 is 0.1 mm at 1/e² (diameter) and an exemplary beam diameter of the incident optical beam at scanning mirror device 260 is 2 mm at 1/e². FIG. 6 illustrates incident optical beam 134I at three different scan positions (angles). The central ray of incident optical beam 134I is denoted 134C. Note the incident optical beam 134I is a converging beam at microplate 170, with the central rays 134C being parallel to optical axis A1 at the microplate.

An exemplary scanning minor device 260 is a MEMS-based mirror (such as the aforementioned TALP1011 from Texas Instruments) having a clear aperture of 3.2 mm×3.6 mm and optical scanning angles θ_{X} and θ_{Y} of +/−10°. The variation of incidence angle γ of incident optical beam 134R over microplate 170 due to aberrations in an exemplary field lens 280 was found in one example system 100 to be less than 0.3 mRd.

Controller 150 is operably connected to light source assembly 106, spectrometer unit 140 and mirror device driver 264, and is configured (e.g., via software embodied in a computer readable medium such as in processor 152 or memory 154) to control the operation of system 100 as described below. In embodiments, controller 150 can be configured with a General Purpose Interface Bus (GPIB) and the devices to which the controller is operably connected can be configured to communicate with the controller using the GPIB.

With reference again to FIG. 5, in the general operation of system 100, controller 150 sends a light source control signal S106 to light source assembly 106 to cause the light source assembly to generate light 120, which is coupled into first fiber section 202 as guided light. Light 120 travels down first fiber section 202 and to third fiber section 206 via coupling device 126. Light 120 is then processed by beam-forming optical system 250, which forms incident optical beam 134I. Incident optical beam 134I is then selectively deflected by scanning mirror device 260 under the operation of a control signal S260 from mirror device driver 264, which in turn is activated by a control signals S264 from controller 150. Because scanning mirror device 260 is located at the focus of field lens 280, in the region between the field lens and microplate, the incident optical beam 134I (or, more precisely, the central ray 134C of this beam) is parallel to optical axis A1 for all deflection angles 170. System 100 can be adjusted so that incident optical beam 134I remains substantially normal to microplate 170 as the beam scans the microplate.

Incident optical beam 134I scans over biosensor 104 as described below and reflects therefrom at substantially normal incidence to form reflected optical beam 134R. Reflected optical beam 134R thus travels substantially the reverse optical path of incident optical beam 134I and is coupled back via beam-forming optical system 250 into third fiber section 206 at end portion 206B and becomes guided light signal 136. Guided light signal 136 then travels through third optical fiber section 206 to second optical fiber section 204 via coupling device 126, where it is received and spectrally decomposed by spectrometer unit 140. Spectrometer unit 140 provides electrical signal S140 representative of the spectral information in reflected optical beam 134R to controller 150 and to memory 154 therein. Memory 154 stores the spectral information as a function of the scanning angles (θ_{X}, θ_{Y}). In embodiments, memory 154 stores and processor 152 runs analysis software for analyzing and visualizing the spectral information, such as Matlab, available from Mathworks, Inc., Natick, Mass.

In embodiments, memory 154 stores a number (e.g., 50) of spectra for each biosensor 102, and processor 152 sums the spectra to obtain a total spectra, and then calculates the centroid to determine resonant wavelength λ_{R}. In embodiments, tens, hundreds, or thousands of spectra can be saved in memory 154 for processing by processor 152. Spectra measurements can be divided up by, for example, individual biosensors 102 or by columns or rows of biosensors.

### Biosensor Scanning

One method of scanning using system 100 is to operate scanning mirror device 260 to scan one or more biosensors 102 in a single scanning direction. However, a shortcoming of this approach is that the resonance wavelength 4 varies significantly as a function of the position of light spot 135 across biosensor 102. Accordingly, in this approach the position of light spot 135 needs to be monitored closely to avoid introducing measurement bias.

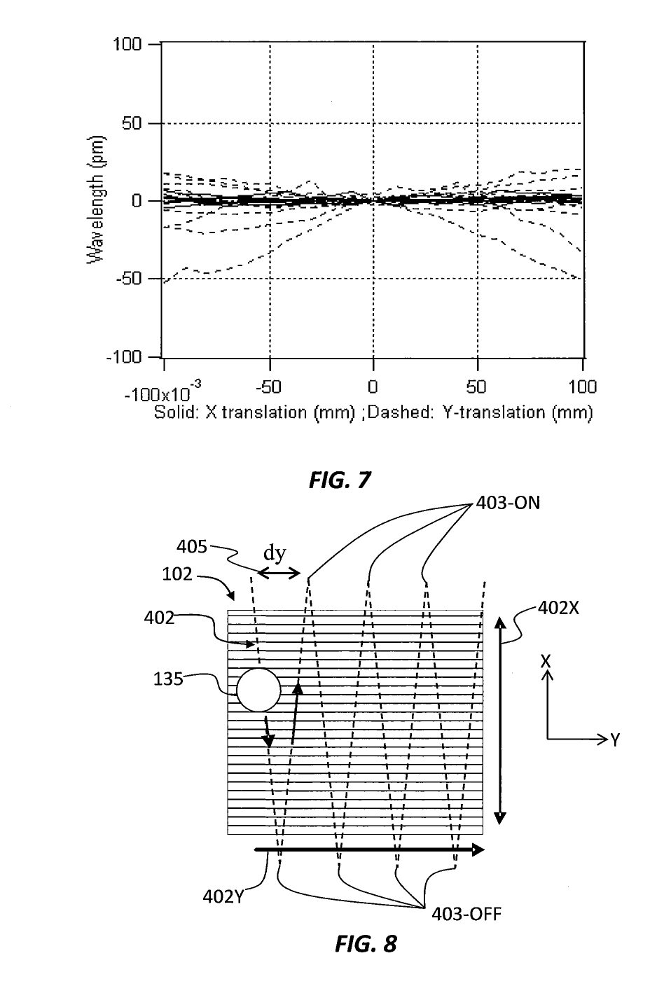

FIG. 7 is a plot of the measured resonant wavelength λ_{R} (pm) versus X and Y displacement (mm) of biosensor 102 as measured on nine different biosensors. During the measurement, optical beam 134I was scanned back and forth (dithered) across the entire biosensor length along the x-direction, but no movement of the optical beam was made in the y-direction. The spectra collected were integrated over a period longer than the back and forth scan time in the x-direction. When microplate 170 is moved perpendicular to the scan axis, a large amount of wavelength change can be observed (dashed lines). When microplate 170 is moved along the scan axis, almost no wavelength change is observed (solid lines). The lesser amount of wavelength change for the x-displacement is observed because, regardless of the biosensor displacement in x, the entire line scan across the biosensor grating is collected due to the x-dither applied to the beam. The plot also shows variations as large as 0.5 pm/micron, which means that measurement bias below 0.1 pm requires re-positioning errors to be lower than 0.2 micrometers, which is relatively difficult to achieve.

Accordingly, a preferred method of operating system 100 involves scanning biosensors 102 with incident optical beam 134I in two dimensions X and Y to obtain an integrated measurement of each scanned biosensor. Because a MEMS-based mirror scanning device can be driven at a relative high frequency (e.g., ≧100 Hz), it is possible to rapidly perform such a two dimensional scan of a sensor. In one example, biosensor 102 is scanned by moving optical beam 134I (and thus light spot 135) faster in one of the two dimensions.

FIG. 8 is a close-up view of an example biosensor 102 and shows an exemplary scan path 402 of light spot 135 (or equivalently, incident optical beam 134I) over at least a portion of the biosensor. Scan path 402 has a scanning pitch dy and uses the Y-axis as the slow-scanning axis (i.e., Y-direction scan path component 402Y) and the X-axis as the fast-scanning axis (i.e., X-direction scan path component 402X), which forms a zig-zag scan path. Rapid scanning of light spot 135 in such a manner allows a much larger “effective light spot” to be created, which can be made larger than biosensor 102. However, unlike creating a large incident optical beam 134I using optical magnification alone, the angular acceptance of the system is not reduced (angular acceptance being proportional to the inverse of the light spot diameter), and system flexibility is maintained to process reflected optical beam 134R from biosensor 102 with high spatial resolution.

An exemplary X-axis scanning rate is about 400 Hz. In an example embodiment, each X-axis scan pass in the +X direction corresponds to a scan reading wherein spectrometer 140 can be activated and processes guided light signal 136. Thus, at turn-around location T-ON in scan path 402, spectrometer 140 is triggered ON by gating or trigger signals SG from controller 150 and starts accumulating photons associated with guided light signal 136. At turn-around locations T-OFF in scan path 402, photon integration triggered off by trigger signal SG from controller 150 and spectrometer 140 sends via signal S140 a single spectrum into memory 54 for further processing by processor 52. As an example, spectrometer 140 is triggered at 400 Hz and the spectral integration time is about 1 millisecond. Assuming, for instance, that the scanning speed in the Y-direction is such that light spot 135 scans the entire biosensor 132 within 0.5 seconds, system 100 collects 200 spectra (0.5 s*400 Hz) per biosensor, with each spectrum being integrated over the entire length of the biosensor along the Y-axis. Alternatively, the signal reflected by biosensor 102 can be integrated during the entire scan time that it takes for optical beam 134I to cover the biosensor in two dimensions. In this example, a single accumulated spectrum contains all of the information about a single measurement of the given biosensor.

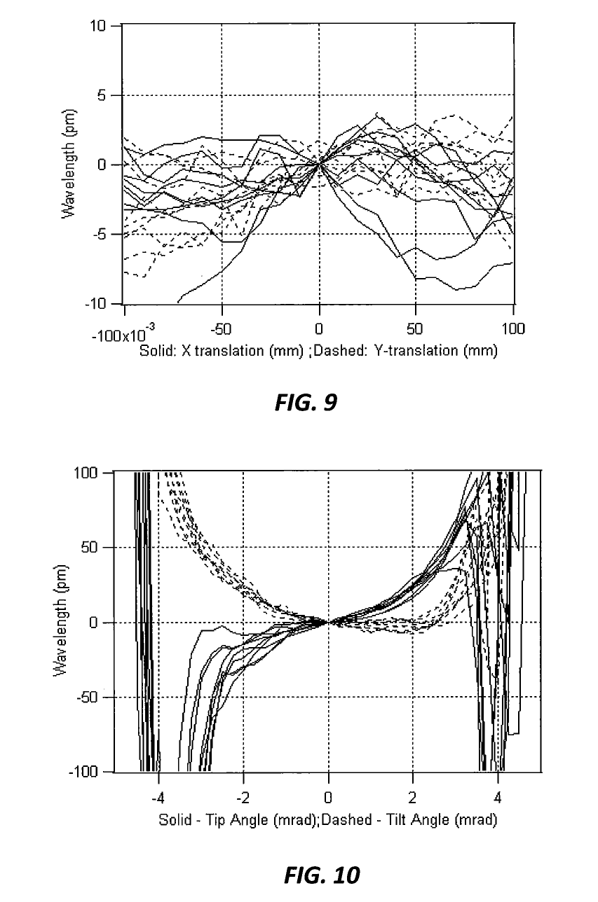

When using a scanning pitch dy smaller than the diameter of light spot 135, the effectively large beam allows the sensitivity to lateral misalignment to be dramatically reduced. FIG. 9 is a plot similar to FIG. 7 and shows experimental measurements of the positioning sensitivity as the same nine biosensors 102 are scanned in 2D rather than 1D. As can be seen, the lateral sensitivity can be reduced by at least a factor of five in the 2D scan over the 1D scan. This removes the need for precise repositioning of microplate 170. This in turn allows for less expensive microplate translation stages 174 to be selected to move microplates 170 in and out of system 100.

In embodiments, scan path 402 traversed by optical beam 134I comprises a zig-zag pattern, such as the sharp triangular wave depicted in FIG. 8, or a sinusoidal path by appropriately modulating the x-axis scan to prevent high frequencies from exciting the resonances of scanning mirror device 260. In embodiments, signal S260 from mirror device driver 264 is a step function combined (e.g., convolved) with a smoothing function (e.g., a Gaussian filter) to create a smoothed step function that avoids “ringing” or other adverse scanning effects that cause deviations in scan path 402 from a desired scan path as a result of driving scanning mirror device 260. In embodiments, incident optical beam 134I can be scanned in 2D (e.g., in a zig-zag fashion as described below) as the incident optical beam travels between biosensors 102 to avoid having to start and stop the scanning process, which can introduce undesirable scan path deviations. In an exemplar of this scanning method, controller 150 sends gating (or triggering) signals SG to spectrometer unit 140, wherein the gating signals timed so that the spectrometer unit only processes reflected optical beams 134R from biosensors 102 and not from the surface of microplate 170.

### Compensation of Microplate Misalignment

The aforementioned U.S. Pat. No. 7,424,178 shows that when using SM fiber sections 202-206, the resonance wavelength λ_{R} is not substantially affected by an angular misalignment. However, second order effects, such as lens aberrations or deviations of the profiles of incident and reflected beams 134I and 134R from a perfect Gaussian shape, can introduce some residual angular dependence on the measurement of the resonant wavelength λ_{R}.

FIG. 10 is a plot similar to FIG. 9 and shows the resonant wavelength variation as a function of the angular tip and tilt of microplate 170 for several biosensor measurements. The curves are reasonably flat for tilt angles below +/−2 mrad, but significantly increase in slope beyond this limit. Precise angular repositioning can be accomplished using a three-point contact microplate holder 174 to provide positional repeatability to about 25 microrad. However, in commercial embodiments it may be desirable to use less expensive and less complicated microplate holders 174 that also have less angular precision. In instances where the angular repositioning of microplate 170 is worse than about 2 mrad, a method of positional compensation may be needed that provides easy realignment of the system.

It is noted that the curves in the plots of FIG. 9 and FIG. 10 are very repeatable from biosensor to biosensor. Thus, the shape of the curves is dictated by the optical aberrations present in the illumination system rather than by the biosensors themselves. Thus, in embodiments, the signal from a reference biosensor 102 is measured and then subtracted from the signal from the biosensors of interest, to remove wavelength shifts due to angular changes of microplate 170.

Thus, in embodiments, system 100 can be configured so that the position of field lens 280 is adjustable relative to scanning mirror device 260 and beam-forming optical system 250. In embodiments, the relative positions of field lens axis A280, scanning mirror device 260 and focusing lens axis A230 are adjustable, i.e., one or more of these elements is displaceable relative to optical axis A1. In embodiments, this adjustability is provided by translation stage 220. The angle of incidence φ of incident optical beam 134I relative to microplate 170 is defined by the vector joining the center of the incident optical beam at focusing lens 230 and the apex of field lens 280. Thus, in embodiments, incidence angle φ of incident optical beam 134I can be adjusted by adjusting the relative position of lenses 230 and 280. Such adjustment can be made in embodiments by adjusting translation stage 220 that includes scanning mirror device 260 and focusing lens 230. This operation does not require translation stage 220 to have high precision. By way of example, for a field lens 280 having a focal length f1=200 mm, the alignment precision only needs to be in the order of 0.2 mm to insure that the precision of incidence angle φ is within 1 mrad. This adjustability makes system 100 substantially insensitive to microplate misalignment.

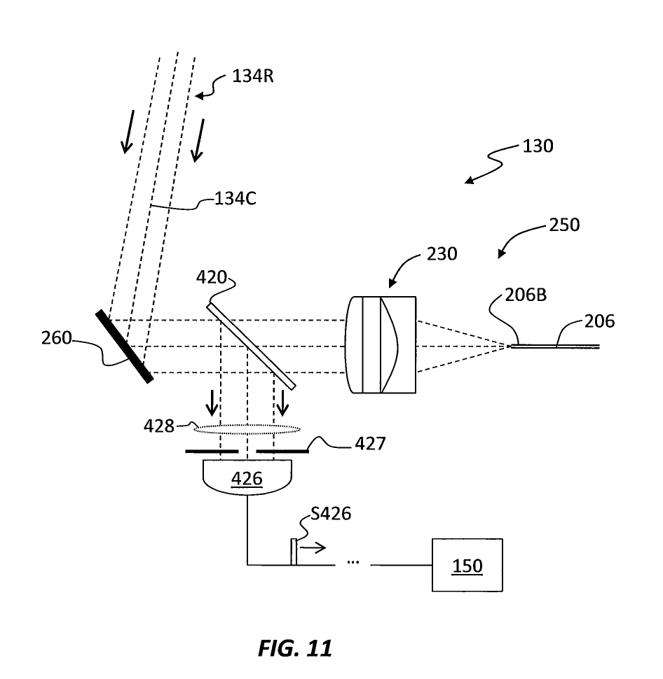

In embodiments, system 100 is aligned by optimizing the optical power coupled back into scanning optical system 130 prior to starting the scanning measurements. FIG. 11 is a schematic close-up view of a portion of scanning optical system 130 for a single-channel optical reader system 100 and illustrates another exemplary system alignment method. The alignment method employs a beam splitter 420 arranged in the optical path between beam-forming optical system 250 and scanning mirror device 260. Beam splitter 420 is configured to direct a portion of reflected optical beam 134R to a photodetector 426 that is laterally aligned with respect to the center of focusing lens 230. Photodetector 426 generates a photodetector signal S426 representative of the amount of optical power detected, and in embodiments, this signal can be directed to controller 150. Photodetector 426 can be, for example, a small-area photodiode, or a photodiode with a limiting aperture 427 in front, as shown in FIG. 11. A lens 428 (shown in phantom) may also be used to focus light onto photodetector 426 in the absence of limiting aperture 427, or in combination therewith. The alignment optimization can be performed by adjusting the position of focusing lens 230 relative to field lens 280 such that the light collected by the photodetector 426 is maximized. In embodiments, this maximization and adjustment process can be accomplished automatically under the operation of controller 150.

Alternatively, the photodetector 26 and limiting aperture 427 may be replaced by a position-sensitive diode or CCD camera. In this instance, the position of the reflected beam 134R on photodetector 26 is monitored, and the adjustment process entails moving the focusing lens 230 relative to the field lens 280 until the reflected beam spot is set to a pre-determined location on the photodetector.

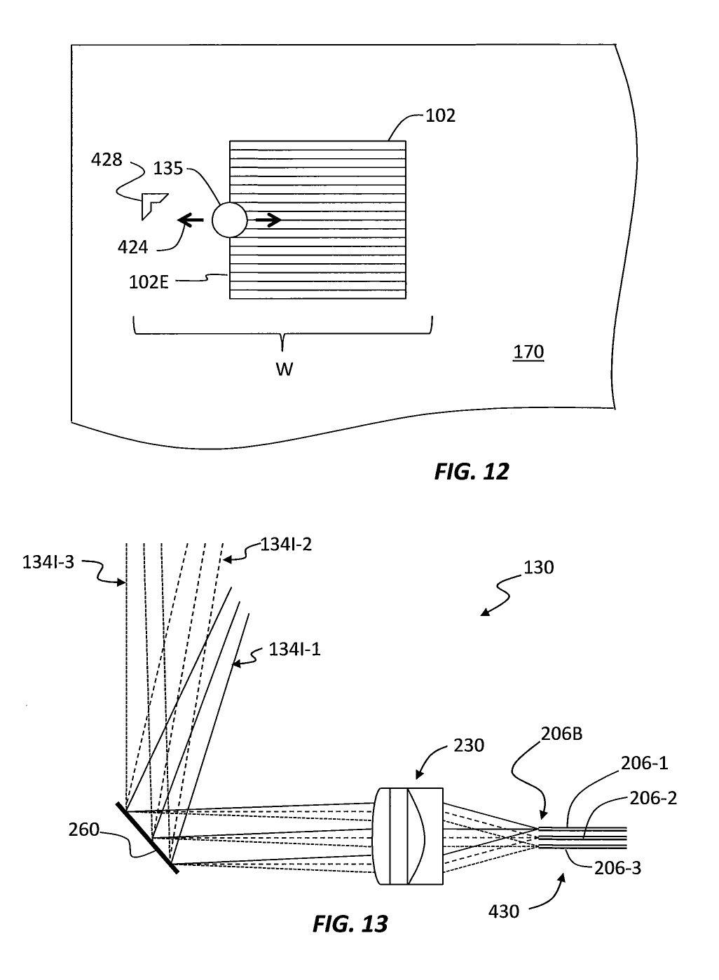

FIG. 12 illustrates an exemplary embodiment of a method of establishing a relative position of microplate 170 within system 100. The microplate position (or biosensor position) is established by directing light spot 135 to an edge 102E of biosensor 102 and then dithering the light spot position relative to the biosensor edge as illustrated by arrows 424. Photodetector 426 records the power of reflected optical beam 134R and symmetric power fluctuation are used to establish the biosensor edge location and thus the microplate position as well as the biosensor position on the microplate. Various edge detection algorithms can be applied to the photodetector signal in processor 152 to establish the position of biosensor edge 102E. The dithering of light spot 135 is accomplished by scanning mirror device 260 being driven in an oscillating manner by mirror device driver 264.

In embodiments, fiducials 428 formed on microplate 170 are used to facilitate microplate alignment. In one method, light spot 135 is scanned over one or more fiducials 428 to establish the position of microplate 170. Other embodiments of systems and methods for aligning microplate 170 in system 100 using fiducials 428 are described in the aforementioned U.S. Patent Application Publication No. 2007/0202543.

### Multiple-Channel Scanning Optical Reader System

Experiments indicate that the ultimate limiting factor for the resolution of system 100 is optical shot noise. Shot noise can be reduced by collecting more photons for each biosensor measurement. Most often, the factor that limits the amount of photons that can be collected is the spectrometer unit 140. The number of photons that can be collected by each pixel in a linear detector array of a spectrometer is given by I=WD/T, where I is the maximum flux of photons that can be collected per second, T is the fastest integration or readout time of the spectrometer detector, and WD is the well depth of the detector, which sets the maximum number of photons that can be collected over the integration time without reaching the saturation threshold.

To increase the maximum detected photon flux to decrease the measurement noise, one can select a spectrometer detector that has deeper wells, or one can increase the speed at which the detector is read out. Another option uses multiple channels each having an associated fiber 206 and spectrometer unit 140. In this instance, the total collected photon flux is multiplied by the number of spectrometers (or “channels”) used.

An exemplary embodiment of system 100 provides for multiple measurement channels while employing a single scanning mirror device 260 by providing multiple fibers 206 arranged in an array 430 at the focus of focusing lens 230. FIG. 13 is a schematic close-up view of a portion of scanning optical system 130 illustrating an exemplary fiber array 430 having three fibers 206-1, 206-2 and 206-3 by way of illustration. The three fibers 206-1, 206-2 and 206-3 are disposed close to the focus of focusing lens 230 and emit respective optical beams 134I-1, 134I-2 and 134I-3 at different pointing angles. Note that any reasonable number of fibers 206 can be used to form array 430, with anywhere from two to about twelve being preferred.

To first approximation, the pointing angle offset of incident optical beams 134I is given by θ=Dyf/f2, where θ is the pointing angle of the incident optical beams, Dyf is the position of an individual fiber with respect to optical axis A1, and f2 is the focal length of focusing lens 230. Hence, an array of optical beams 134I is directed to microplate 170, with the position separation of the beams at the microplate given by:

Dyp=θ*f1=Dyf*f1/f2

where Dyp is the separation between the incident optical beams at microplate 170 and f1 is the focal length of field lens 280.

By properly setting the pitch P of fiber array 430, the separation of light spots 135 associated with input optical beams 134I can be made to correspond to an integer number times the pitch P′ of biosensors 102 in biosensor array 102A. The separation of optical beams 134I at fiber ends 206B can be magnified by a factor of (f1/f2) at microplate 170 by the operation of lenses 230 and 280. As a consequence, the image of each fiber end 206B is centered on a specific biosensor 102 so that each fiber interrogates (illuminates) a different area of microplate 170. As an example, for f1=200 mm and f2=10 mm, and a biosensor array pitch P′ of 4.5 mm, the pitch P of fiber array 430 is 0.225 mm.

As scanning mirror device 260 scans, the array of optical beams 134I moves and the corresponding reflected optical beams 134R from each illuminated biosensor 102 are simultaneously collected by their respective fibers 206 as described above. In general, n fibers 206 can be used to form n-channels, where n is an integer is equal to or greater than 1. The guided light signal 136 in each fiber 206 is then routed to a corresponding spectrometer unit 140 (e.g., 140-1, 140-2, etc.), as illustrated in FIG. 14 for n different fibers 206 and n spectrometer units 140. Note that coupling device 126 becomes a n×2n coupling device in this configuration, with light source 106 being coupled to n fiber sections 202-1, 202-2, . . . 202-n, which sections may be configured in a optical fiber cable 202C. Fiber sections 204 and 206 can be also be configured in respective optical fiber cables 204C and 206C. In embodiments, the various multiple optical fiber sections can be combined into respective optical fiber ribbon sections or cables.

### Dual-Head Optical Reader System

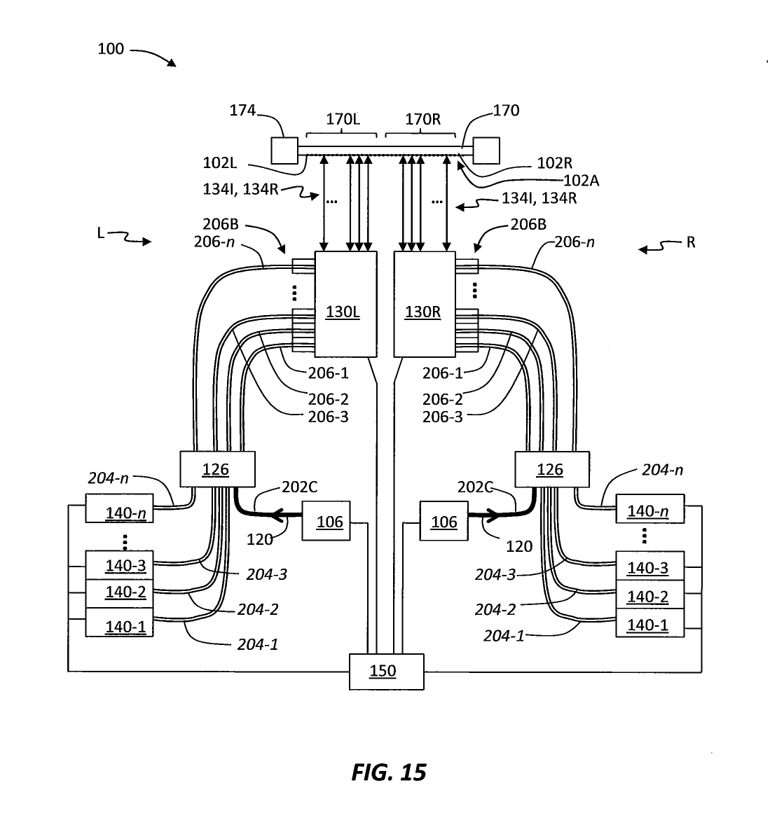

FIG. 15 is a schematic diagram of another exemplary embodiment of a “dual-scanning” multiple-channel optical reader system 100 that combines two of the single or multichannel systems described above. System 100 of FIG. 15 has “left” and “right” sides denoted L and R, and utilizes two scanning optical systems 130 (shown as 130L and 130R) that each interrogate sub-regions 170L and 170R of microplate 170 in a scanned fashion as described above in order to measure respective arrays 102A of biosensors 102 (see FIG. 1). Each of the two scanning optical systems 130L and 130R is shown configured in the multiple channel embodiment of system 100 described above, where one side of the system is essentially a reflection of the other, but is configured to operate under the control of a single controller 150.

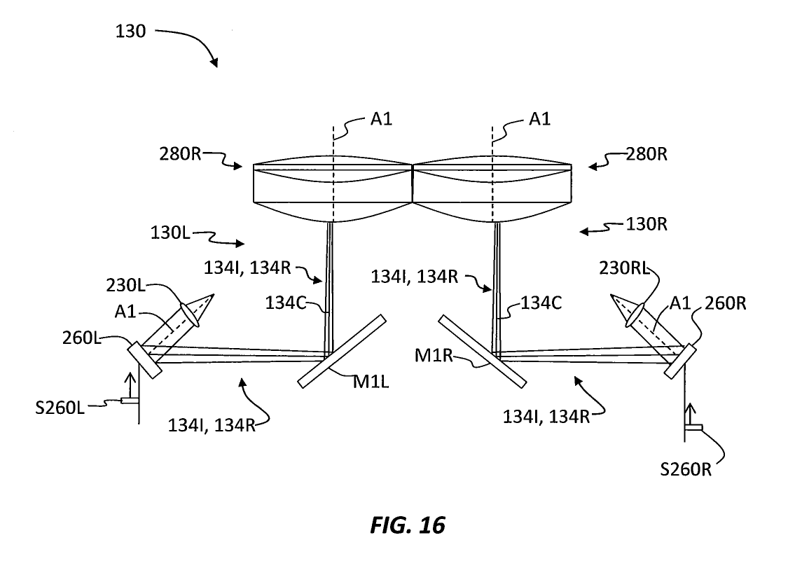

FIG. 16 is a schematic diagram of an exemplary configuration of the two (i.e., left and right) scanning optical systems 130L and 130R suitable for use in the dual scanning system 100 of FIG. 15.

FIG. 17 is schematic diagram similar to FIG. 15 that illustrates an exemplary embodiment of dual-head optical reader system 100 that uses only one set of one or more spectrometer units 140. This is accomplished by controller 150 and mirror device drivers 264 driving the respective scanning mirror devices 260 in an asynchronous manner so that only one set of reflected optical beams 134R (and thus one set of guided light signals 136) is processed by the one or more spectrometer units 140 at a time. In an example of this approach, signal S260L applied to scanning mirror 260L (see FIG. 16) is slightly offset (i.e., time-delayed) relative to signal S260R applied to scanning mirror device 260R. The consequence of this time delay is that, when scanning spot 135 associated left scanning optical system 130L is on a biosensor 102L, the scanning spot 135 (not shown in FIG. 17; see FIG. 8) associated with right scanning optical system 130R is in-between two biosensors 102R.

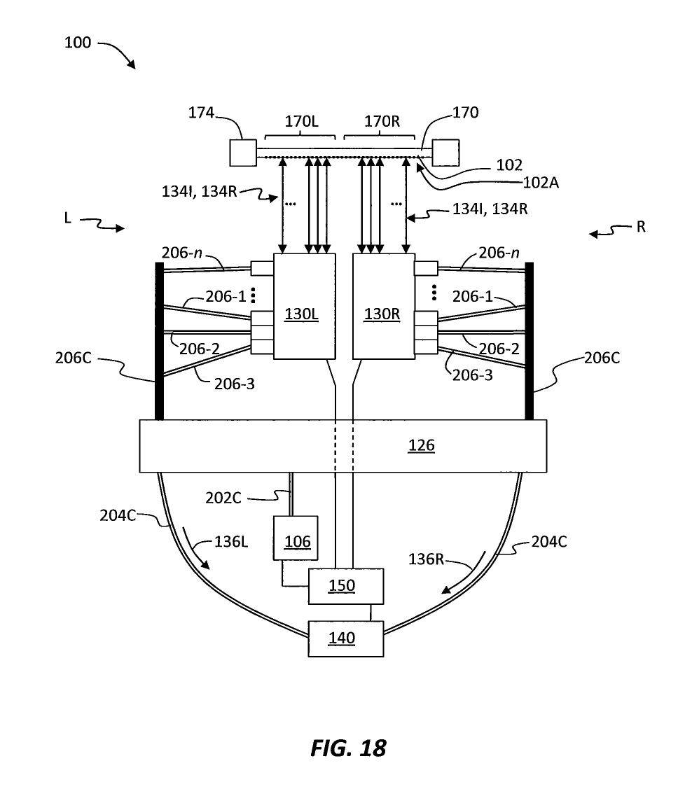

Consequently, while one scanning optical system 130 is generating a guided light signal 136, the other is generating no guided light signal. By interleaving the two guided light signals 136L and 136R, (e.g., via one or more coupling devices 126), and sending them to the one or more spectrometers 140 while tracking the delayed generation of scanning mirror signals S260L and 260R, the guided light signals from each scanning optical system and thus the corresponding spectrometer unit electrical signals S140 are tracked. System 100 of FIG. 17 is shown configured with the various fiber sections 202, 204 and 206 in the form of optical fiber cables (e.g., ribbon cables) 202C, 204C and 206C that carry one or more of the respective optical fiber sections 202, 204 and 206. FIG. 18 is similar to FIG. 17 and illustrates a simplified example embodiment wherein system 100 includes a single coupling device 126, a single light source 160 and a single spectrometer unit 140.

While the dual-head optical reader optical system 100 can be more expensive to implement than the single-scanning optical reader, it is capable of making a relatively large number of scanned measurements of an array of biosensors 102 in a relatively short amount of time, e.g., a microplate 170 having an array of 16×24 biosensors 102 can be read in about 20 seconds.

It will be apparent to those skilled in the art that various modifications to the preferred embodiment of the disclosure as described herein can be made without departing from the spirit or scope of the disclosure as defined in the appended claims. Thus, the disclosure covers the modifications and variations provided they come within the scope of the appended claims and the equivalents thereto.

What is claimed is:

1. A optical reader system for label-independent reading of resonant-waveguide (RWG) biosensors operably supported by a microplate, comprising:
a holder configured to operably hold the microplate in the system;
a light source that generates light;
a spectrometer unit;
a beam-forming optical system having input and output ends and optically coupled to the light source at the input end, the beam-forming optical system being configured to form from the light at least one optical beam at the output end, and being optically coupled to the spectrometer unit at the input end to direct light received at the output end to the spectrometer unit; and
a scanning optical system arranged between the microplate and the beam-forming optical system and comprising a scanning mirror device, a mirror device driver operably coupled to the scanning mirror device, and an F-theta lens, wherein the scanning optical system is configured to receive and scan the at least one optical beam over one or more of the RWG biosensors and to direct light reflected by the one or more scanned RWG biosensors back to the output end of the beam-forming optical system.

2. The optical reader system of claim 1, wherein the beam-forming optical system includes:
one or more optical fibers each having an end; and
one or more lenses respectively arranged adjacent the one or more optical fiber ends and configured to form an image of the one or more fiber ends on the microplate

3. The optical reader system of claim 1, wherein the scanning mirror device is selected from the group of scanning mirror devices comprising at least one of: a micro-electro-mechanical system (MEMS) mirror, a scanning galvanometer, a flexure-based scanning mirror, an oscillating plane mirror, a rotating multifaceted mirror, and a piezo-electric-driven mirror.

4. The optical reader system of claim 1, wherein the scanning optical system forms a light spot and the system is configured to scan the light spot over the RWG biosensor in two dimensions.

5. The optical reader system of claim 2, wherein respective axes of the F-theta lens of scanning optical system and at least one of the one or more lenses of the beam-forming optical system are adjustable relative to one another to maintain optical alignment relative to the microplate.

6. The optical reader system of claim 1, wherein at least one beam-forming optical system is optically coupled to the light source by a first optical fiber section and is optically coupled to the spectrometer unit by a second optical fiber section.

7. The optical reader system of claim 1, wherein the scanning optical system is configured to dither the at least one optical beam over an edge of the at least one RWG biosensor to establish a position of the at least one RWG biosensor.

8. The optical reader system of claim 2, wherein the RWG biosensors are arranged in an array having a first array spacing, and wherein the beam-forming optical system comprises an array of optical fibers having a second array spacing and forms an image of the fibers at the sensor plate that corresponds to the first array spacing.

9. An optical reader system for label-independent reading of RWG biosensors operably supported by a microplate, comprising:
at least one light source that generates light;
at least one spectrometer unit;
first and second beam-forming optical systems each having input and output ends and optically coupled to either different light sources or to the at least one light source at their respective input ends form at least one first optical beam and at least one second optical beam at their respective output ends, and optically coupled to either different spectrometer units or to the at least one spectrometer unit at their respective input ends to direct thereto light received at their respective output ends; and
first and second scanning optical systems respectively arranged between the microplate and the first and second beam-forming optical systems and respectively comprising first and second scanning mirror devices, first and second mirror device drivers respectively operably connected to the first and second scanning mirror devices, and first and second F-theta lenses respectively operably arranged relative to the first and second scanning mirror devices, and respectively configured to scan the at least one first optical beam and the at least one second optical beam over respective RWG biosensors, and to direct light reflected by the scanned RWG biosensors back to the corresponding output ends of the first and second beam-forming optical systems.

10. The optical reader system of claim 9, further comprising a single light source and a single spectrometer respectively optically coupled to the first and second beam-forming optical systems.

11. The optical reader system of claim 9, wherein the first and second optical beams have associated therewith respective first and second light spots, and wherein the first and second scanning optical systems are configured to scan the first and second light spots in two dimensions over the corresponding RWG biosensors.

12. The optical reader system of claim 9, wherein the first and second beam-forming optical systems respectively include:
one or more first and second optical fibers each having an end; and
one or more first and second focusing lenses respectively arranged adjacent the one or more first and second optical fiber ends,
wherein the one or more first and second focusing lenses and the first and second scanning mirror devices are adjustable relative to the corresponding first and second F-theta lenses to maintain respective alignment therewith relative to the microplate.

13. The optical reader system of claim 9, wherein the first and second scanning optical systems are configured such that when the at least one first optical beam is illuminating the corresponding at least one RWG biosensor, the at least one second optical beam is not illuminating any of the RWG biosensors.

14. The optical reader system of claim 9, wherein the RWG biosensors are arranged in an array having a sensor-array spacing, and wherein the first and second beam-forming optical systems respectively comprise first and second arrays of first and second optical fibers having respective first and second array spacings and form images of the first and second fibers at the microplate that correspond to the sensor-array spacing.

15. A method of reading an array of resonant waveguide (RWG) biosensors operably supported by a microplate, comprising:
generating at least one optical beam using at least one beam-forming optical system that is optically connected to a light source and to a spectrometer unit;
providing at least one scanning optical system comprising a scanning mirror device, a mirror driver operably coupled to the scanning mirror device, and an F-theta lens operatively arranged relative to the adjustable mirror.
operating the at least one scanning optical system to effectuate scanning of the at least one optical beam over at least one RWG biosensor without moving the microplate to generate a reflected optical beam therefrom;
directing light from the reflected optical beam to the spectrometer through the at least one scanning optical system and the at least one beam-forming optical system to form at least one measurement spectrum; and
processing the at least one measurement spectrum to establish at least one resonant wavelength associated with the at least one scanned RWG biosensor.

16. The method of claim 15, further comprising:
generating multiple optical beams using multiple beam-forming optical systems;
operating a single scanning optical system to effectuate scanning of each of the multiple optical beams over corresponding RWG biosensors; and
directing light reflected from the RWG biosensors to the corresponding beam-forming optical system.

17. The method of claim 15, further comprising:
generating first and second sets of optical beams using first and second arrays of optical fibers respectively residing in the first and second beam-forming optical systems and that are operably connected to at least one light source and to at least one spectrometer unit;
scanning the first and second sets of optical beams over respective first and second sets of RWG biosensors using first and second scanning optical systems, thereby generating first and second sets of reflected optical beams; and
directing light from the first and second sets of reflected optical beams to the at least one spectrometer unit through the corresponding first and second arrays of optical fibers.

18. The method of claim 17, wherein the scanning of the first and second sets of optical beams is performed such that when the first set of optical beams is scanning corresponding RWG biosensors, the second set of optical beams is not scanning any RWG biosensors.

19. The method of claim 18, including directing the light from the first and second sets of the reflected optical beams to a single spectrometer unit.

20. The method of claim 15, further comprising:
collecting multiple spectra from one of the RWG biosensors;
combining the multiple spectra; and
determining from the combined multiple spectra the at least one resonant wavelength of the one RWG biosensor.

21. The method of claim 15, wherein the at least one beam-forming optical system has a focusing lens, the method further including:
adjusting respective axes of the F-theta lens and the focusing lens relative to one another to maintain optical alignment relative to the microplate.

22. A method of reading a resonant waveguide (RWG) biosensor having a resonant wavelength, comprising:
forming a scanned optical beam having a light spot smaller than the RWG biosensor;
scanning the light spot in a two-dimensional scan path over at least a portion of the RWG biosensor thereby forming reflected light containing resonant wavelength information from multiple locations on the biosensor;
collecting the reflected light over the scan path; and
determining from the reflected light a spatially integrated measurement of the resonant wavelength.

23. The method of claim 22, wherein the scanned light spot moves faster in one of the two dimensions.

24. The method of claim 22, wherein the RWG biosensor has two opposite edges and the scan path has a zig-zag pattern that crosses the two opposite edges.

25. The method of claim 22, wherein the reflected light includes multiple spectra, and further including combining the multiple spectra in determining the integrated measurement of the resonant wavelength.
